(19) United States
(12) Patent Application Publication
(10) Pub. No.: US 2021/0156521 A1
(43) Pub. Date: May 27, 2021

(54) Pipeline Product Batch Change Indication Method And System

(71) Applicant: GHD Services, Inc., Waterloo (CA)

(72) Inventors: Michael Laschinger, Grand Island, NY (US); Michael O'Donnell, Getzville, NY (US); Eric Spina, Angola, NY (US)

(21) Appl. No.: 17/047,921

(22) PCT Filed: Apr. 22, 2019
(86) PCT No.: PCT/IB19/00608

§ 371 Date: Oct. 15, 2020

Related U.S. Application Data
(60) Provisional application No. 62/660,824, filed on Apr. 20, 2018.

(51) Int. Cl. F17D 3/03; G01N 9/36; G01N 21/00

(52) U.S. Cl. CPC F17D 3/03; G01N 21/00; G01N 9/36

(57) ABSTRACT

A method and system for operating a pipeline conveying two dissimilar materials that gathers data about material flowing in the pipeline, identifies a first line and determines a slope of the first line of a first subset of the gathered data, and if an absolute value of the slope of the first line equals or exceeds a first threshold value, then sends a message indicating that transmix has been detected; identifies a second line and determines a slope of the second line of a second subset of the gathered data, and if an absolute value of the slope of the second line equals or is less than a second threshold value, then sends a message indicating that transmix has ended. A position of at least one valve is modified in response to the message that transmix has ended.

### CROSS-REFERENCE TO RELATED APPLICATION

This application claims the benefit of priority to U.S. provisional patent application Ser. No. 62/660,824, filed on Apr. 20, 2018.

### FIELD OF THE INVENTION

The invention relates to the monitoring and safe operation of a pipeline system that delivers fluids, such as refined petroleum products.

### BACKGROUND OF THE INVENTION

Pipelines are used to transport many types of fluid materials including refined petroleum products. For many pipelines, various types or grades of materials are transported through the same pipe at different times. For example, a pipeline may be used to transport gasoline having an octane rating of 87 (so called “regular” gasoline) during a first time period, and then during a second time period the pipeline may be used to transport gasoline having an octane rating of 93 (so called “premium” gasoline). When the desired amount of regular gasoline has been pumped into the pipeline, pumping of the premium gasoline into the pipeline may immediately begin. The velocity profile of the pipeline and other operating factors result in some mixing of adjacent batches of materials. So, in this example, the final portion of the regular gasoline may mix with the initial portion of the premium gasoline. Such mixing results in a material that may not meet the specifications of either of the adjacent materials. Herein, that mixed material formed from adjacent batches is referred to as the “transmix”.

To ensure product quality, actions must be taken in order to properly handle the transmix. Such actions usually include adjusting valves so that the transmix is sent to a desired storage tank. Such actions may be taken manually by a human operator, or automatically by systems that are managed by computers and/or human operators. For example, in some situations, the transmix may be diverted to a storage tank that can tolerate an amount of mixed materials without affecting the overall quality of the material in that storage tank. In other situations, the transmix will be diverted to a separate tank for reprocessing at a later time. Changes to the pipeline, such as adjusting valves, are normally made after receiving information about the material being transported by the pipeline. One or more monitoring instruments may be mounted to the pipeline for measuring one or more characteristics of the material inside the pipeline. For example, instruments used to monitor characteristics of refined petroleum products typically measure density or an optical property, such as absorption, fluorescence, refractive index, color, haze, turbidity. An instrument that measures an optical characteristic may be referred to as an optical interface detector (“OID”). A monitoring instrument that measures density may be referred to as a densitometer. Instruments that measure a characteristic of a material inside the pipeline often provide an electric signal that indicates a measurement obtained by the instrument, and that electric signal can be transmitted over some distance in order to inform a human operator and/or computer about the measured characteristic. For example, such a signal may be interpreted as indicating that the material inside the pipeline has a particular density value or refractive index value. The values obtained from such instruments may be taken periodically so that changes in the material flowing through the pipeline can be detected over time. For example, a change in density may indicate that the material flowing in the pipeline is changing from regular gasoline to premium gasoline. By monitoring signals from such instruments, it is possible to determine when a change to the pipeline should be made in order that one batch of material is sent to a desired location that is different from a desired location for an adjacent (and different) batch of material. For example, when using a density setpoint method, the beginning or end of the transmix is identified once the density reading crosses the setpoint. This has the shortcomings that the setpoint must be chosen to be sufficiently different from the initial batch's actual density so that normal fluctuations in density reading do not falsely indicate the arrival of transmix associated with a batch change. As such, the density setpoint method is subject to false indications if the set point threshold is set too close to the batch density, or failing to timely identify the start or end of the transmix if the set point threshold is set too far from the batch density.

FIG. 1 depicts a portion of a prior art pipeline system having two densitometers. A preview meter (e.g. a densitometer) is located on an incoming pipe that delivers material to a fuel terminal. The preview meter is located a distance upstream of the meter station delivery valves (typically 100 yards to 2 miles upstream) in order to allow the identification of a batch change in advance, and also to afford enough time to make change to the valves at a time that coincides with the change of materials flowing through the pipeline. A station meter (e.g. a densitometer) is shown located near storage tanks holding common refined petroleum materials, such as diesel, regular gasoline, and premium gasoline. A separate storage tank is also shown in FIG. 1 for transmix. The meters may emit signals that are indicative of the characteristic (e.g. density) being measured, and those signals transmitted, for example using analog signal wiring or by digital signal communication, to a computer for storage and/or analysis.

By monitoring the preview meter, an operator may know in advance that a change in the material carried by the pipeline will soon reach the pipeline valve. If the material in the pipeline should be sent to the fuel terminal, the pipeline valve may be closed and the station valve may be opened so that the material flows to the fuel terminal. Also, the operator may open the valve to the desired storage tank, and close others of the valves so that the material in the pipeline flows to the proper storage tank. By timing the opening and closing of valves, the operator may reduce the amount of material that must be sent to the transmix tank, and may also avoid contaminating a particular storage tank with material that belongs in a different storage tank. From FIG. 1, it can be seen that accurate identification of batch changes and valve actuation are necessary to prevent cross contamination of materials.

Although systems exist for assisting with achieving a proper configuration of the pipeline valves at a desired time, those systems often rely on the experience and/or educated guesses of human operators. Such experience and educated guesses usually, but not always, results in an acceptable outcome, but rarely an ideal outcome. Also, such experience and educated guesses vary from person to person, thereby resulting in varied results even if the data is the same. Computer systems have been employed to reduce the chances of mistakes by these human operators, but such computer systems are often based on the same experience and educated guesses, and therefore usually serve merely as a check on the human operators, or to warn a human operator when his/her attention has been diverted to other matters. Even with recent advances in instrumentation, computers, and the software running those computers, pipeline monitoring and control systems too often do not achieve a desired outcome, which usually results in material provided by the pipeline being wasted, needing rework, or downgrading from higher-valued material to lower-valued material. The resulting economic and environmental losses are significant.

### SUMMARY OF THE INVENTION

Embodiments of the invention seek to provide for more reliable operation of a pipeline that results in (a) more material arriving at a desired destination, (b) less waste, and (c) less economic loss compared to existing methods. A system according to the invention may include a computer programmed to receive data from an instrument that monitors characteristics of material flowing through a pipeline. That data may be used to determine the composition of the transmix at a plurality of times, and by monitoring the composition of the transmix over time, a prediction may be provided with respect to an optimal time to change the configuration of the pipeline in response to a change in the material carried by the pipeline. It should be noted that although data may be gathered on a temporal basis (e.g. collect a data point every 30 seconds), data also may be gathered on a volumetric basis (e.g. collect a data point every 100 gallons).

The invention may be embodied as a method of determining (a) the amount of mixing and (b) the composition of fluid residing between adjacent batches of material, such as petroleum products, as various materials are moved through a pipeline system. The invention may produce data that can be used to automate some aspects of pipeline operation and to improve the efficiency of pipeline operation. The invention may use data from analytical instruments to estimate the composition of materials moving through the pipeline, and may use it to assist with deciding when to alter a configuration of the pipeline so that the various materials arrive at desired destinations.

The invention may be embodied as a method of operating a pipeline that conveys two dissimilar materials. In such a method, data may be gathered, and that data may correspond to a measured characteristic for material flowing in a pipeline that has valves for directing the material to desired locations. The measured characteristic may be the density of the material flowing through the pipeline, or may be absorption, fluorescence, refractive index, color, haze or turbidity of the material flowing through the pipeline.

Using the gathered data, identify a first line that is representative of a first subset of the gathered data. A slope of that line may be determined, and compared to a first threshold value. For example, an absolute value of that slope may be compared to the first threshold value, and a determination made regarding whether the absolute value of the slope of the first line is less than, equals, or exceeds the first threshold value. If the absolute value of the slope of the first line is determined to be less than the first threshold value, then continue gathering data corresponding to the measured characteristic, and at a later time repeat the process of determining a line that is representative of another subset of the gathered data, determine a slope of that line, and compare that slope to the first threshold value.

If the absolute value of the slope of the first line equals or exceeds the first threshold value, then the following may be undertaken:
(i) send a message indicating that transmix has been detected;
(ii) continue gathering data corresponding to the measured characteristic;
(iii) identify a second line that is representative of a second subset of the gathered data, the second subset including data gathered in step “ii”;
(iv) determine a slope of the second line;
(v) determine whether an absolute value of the slope of the second line is less than, equals, or exceeds a second threshold value;
(vi) if the absolute value of the slope of the second line exceeds the second threshold value, then return to step “ii”;
(vii) if the absolute value of the slope of the second line equals or is less than the second threshold value, then send a message that the transmix has ended; and
(viii) in response to the message that the transmix has ended, modify a position of at least one of the valves to direct the material to a desired location via the pipeline.
   Steps “i” through “vi” may be carried out by one or more computers executing instructions of software programs. Also, step “vii” may be carried out by one or more computers executing instructions of software programs.

Step “viii” may be carried out so that the position is modified (a) before the transmix arrives at the valve, (b) after the transmix has passed the valve, or (c) after the transmix arrives at the valve, but before the transmix has passed the valve.

A monitoring instrument may be used to gather the data. The monitoring instrument may be mounted on and/or in the pipeline, and the mounting location may be upstream of at least one of the pipeline valves that may be used to direct material to desired locations. Such a monitoring instrument may be a densitometer, or an OID. If the monitoring instrument is an OID, the OID may monitor absorption, fluorescence, refractive index, color, haze or turbidity of the material flowing through the pipeline.

Identifying the first line, identifying the second line, determining the first slope, and determining the second slope may be carried out by one or more computers executing instructions of software programs. Also, one or more computers executing instructions of software programs may be used to compare slopes of those lines to threshold values, and to determine whether the slopes are less than, equal to, or exceed the corresponding threshold value. For example, one or more computers may be used to compare an absolute value of the slope of the first line to the first threshold value, and to determine whether that absolute value is less than, equal to, or exceeds the first threshold value. And, one or more computers may be used to compare an absolute value of the slope of the second line to the second threshold value, and to determine whether that absolute value is less than, equal to, or exceeds the second threshold value.

A method according to the invention may be further carried out so as to determine a volume occupied by the transmix. Using that information about the volume occupied by the transmix, the method may further include determining that the transmix has passed when a volume measured by a flow meter exceeds the determined volume of the transmix. In such a method, a flow meter residing downstream of the monitoring meter may be used. When the transmix reaches that flow meter, the flow meter is used to monitor the volume of material that passes by the flow meter. When the flow meter indicates that the quantity of material that has passed by equals or exceeds the volume of the transmix, a message may be sent indicating that the transmix has passed by the flow meter. In response to receiving that message, a determination may be made regarding when to modify the position of at least one of the valves in order to direct the material flowing in the pipeline to a desired location.

The invention may be embodied as a system for operating a pipeline conveying two dissimilar materials. Such a system may include:
(a) a monitoring instrument for gathering data corresponding to a characteristic for material flowing in a pipeline that has valves for directing the material to desired locations;
(b) one or more computers programmed to:
   (i) identify a first line that is representative of a first subset of the gathered data;
   (ii) determine a slope of the first line;
   (iii) determine whether an absolute value of the slope of the first line is less than, equals, or exceeds a first threshold value;
   (iv) if the absolute value of the slope of the first line is determined to be less than the first threshold value, then continue gathering data with the monitoring instrument;
   (v) if the absolute value of the slope of the first line equals or exceeds the first threshold value, then:
      (A) send a message indicating that transmix has been detected;
      (B) continue gathering data corresponding to the measured characteristic;
      (C) identify a second line that is representative of a second subset of the gathered data, the second subset including data gathered in step “B”;
      (D) determine a slope of the second line;
      (E) determine whether an absolute value of the slope of the second line is less than, equals, or exceeds a second threshold value;
      (F) if the absolute value of the slope of the second line exceeds the second threshold value, then return to step “B”;
      (G) if the absolute value of the slope of the second line equals or is less than the second threshold value, then send a message that the transmix has ended.
         The monitoring instrument may be mounted on and/or in the pipeline. The monitoring instrument may be mounted upstream of the at least one valve. The monitoring instrument may be a densitometer or an OID. If the monitoring instrument is an OID, the OID may monitor absorption, fluorescence, refractive index, color, haze or turbidity of the material flowing through the pipeline.

In such a system, the computer may be further programmed to modify a position of at least one of the valves to direct the material to a desired location via the pipeline in response to the message that the transmix has ended. The position of the valve may be modified so that the position is modified (a) before the transmix arrives at the valve, (b) after the transmix has passed the valve; or after the transmix arrives at the valve, but before the transmix has passed the valve.

In an embodiment of the invention, the computer may be further programmed to determine a volume occupied by the transmix. In addition, the computer may be programmed to use that information about the volume occupied by the transmix, to determine that the transmix has passed when a volume measured by a flow meter exceeds the determined volume of the transmix, and then in response, modify a position of a pipeline valve in order to direct the material flowing in the pipeline to a desired location.

### BRIEF DESCRIPTION OF THE FIGURES

For a fuller understanding of the nature and objects of the invention, reference should be made to the accompanying drawings and the subsequent description. Briefly, the drawings are:

FIG. 1 is a schematic representation of a portion of a pipeline at a location having a fuel terminal where refined petroleum products may be stored;

FIG. 2 is a flow chart showing a sequence of events for a batch change that is in keeping with the invention;

FIG. 3 is a graph showing a change in density that may occur when changing from a first batch of material comprising diesel oil to a second batch of material comprising gasoline;

FIG. 4 is a graph showing a non-ideal change in density that can occur when transitioning from one batch of material to another batch of material;

FIG. 5 describes algorithms associated with a method that is in keeping with the invention;

and

FIG. 6 is a graph showing how density might change at the end of a transmix.

### FURTHER DESCRIPTION OF THE INVENTION

The invention may include a method of evaluating material flowing in a pipeline system and deciding when to change a configuration of the pipeline system in response to a change in the material flowing through the pipeline. In one such method, a characteristic of the material may be periodically determined and a value may be assigned. For example, the characteristic may be the density of material flowing through the pipeline. A densitometer may be used to determine the material density, and a signal representing the determined density may be sent to a data storage device. Other characteristics may be used, for example, an optical property such as absorption, fluorescence, refractive index, color, haze, and/or turbidity. The invention is not limited to such characteristics, and these are merely provided as examples of the types of characteristics that may be periodically determined for a material inside a pipeline. A desired number of such measurements may be collected and stored over time in order to provide a series of data that collectively indicate how the measured characteristic has changed with time. It should be noted that although data may be gathered on a temporal basis (e.g. collect a data point every 30 seconds), data also may be gathered on a volumetric basis (e.g. collect a data point every 100 gallons).

The stored data may be used to calculate a transmix composition for the time period over which data was gathered by the instrument. By knowing the characteristic of an initial batch of material and the expected value of the characteristic for a subsequent batch of material, a prediction may be made regarding when the subsequent material will arrive at a particular location on the pipeline. For example, by knowing how the composition of the transmix is changing at the start of a change from an initial batch to a subsequent batch, the invention may produce a predicted time when the position (open vs. closed) of a valve on the pipeline should be modified. A change to the valve position, and thus the pipeline configuration, can then be performed automatically by a control system or be performed manually by an operator based on his/her judgement.

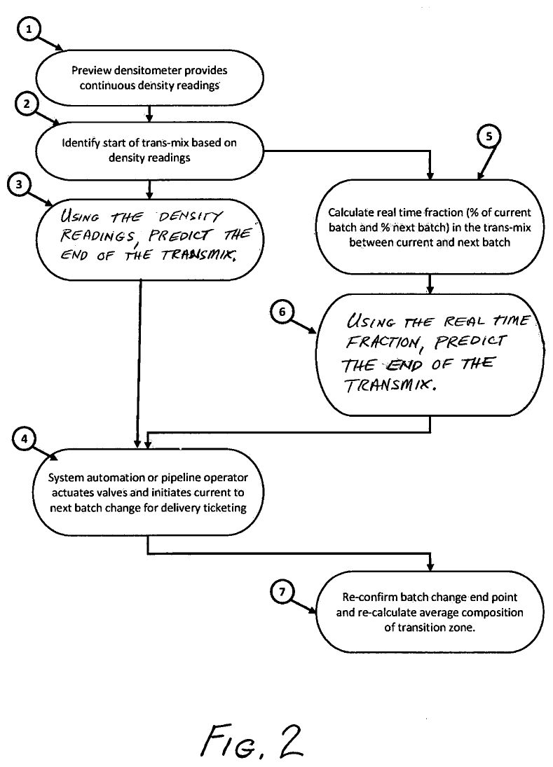

With FIG. 2 in mind, a method according to the invention may be carried out by using an instrument (such as a densitometer) to monitor a material characteristic (such as density). The instrument may produce a signal indicating a value of the monitored characteristic, and those values may be stored, for example on a temporal interval or on a volumetric interval. For example, the volume interval may be each barrel (1 barrel=42 gallons) of material that passes through the measuring instrument. For some fuel terminals, an appropriate volume-interval may be in the range of from 0.1 to 20 barrels, depending on the type and quantity of material being carried by the pipeline. Alternately, the values of the monitored characteristic may be stored on a consistent time interval, which may be selected to be in the range of from 1 to 30 seconds. The stored values may be used to identify a start and predict an end of the transmix.

FIG. 2 describes a sequence of events that may occur when material delivered via a pipeline changes from a first material to a second material. In Step 1, a characteristic of the material in the pipeline may be monitored by an instrument. In this instance, the instrument may be a densitometer and the characteristic being monitored may be the density of the material flowing past the densitometer. The density value provided by the densitometer may be both displayed on a monitor for a human operator to view, and used by a computer to identify the beginning of the transmix.

In Step 2, the start of the transmix may be identified. It should be noted that measurements taken by instruments can vary even if the material being monitored does not change. And, in most pipeline systems the material being monitored is not uniform over time. Therefore, the instrument may indicate changes in the monitored characteristic even when there is no transmix present. Thus, identifying the start of the transmix may not be merely a matter of detecting a change in the monitored characteristic. However, if the monitored characteristic is outside an expected range for that characteristic, it may be that a transmix has started. When the monitored characteristic is outside the expected range, additional activities (described below) may be undertaken to identify when the transmix began to arrive at the monitoring instrument, and also to predict when the end of the transmix will arrive at the monitoring instrument.

The values of the measured characteristic may be used to predict when the transmix began to arrive at the monitoring instrument. From past experience, it may be possible to identify a slope value that can be used as a threshold corresponding to a change between two types of materials. By comparing the calculated slope to the threshold slope, it is possible to identify the start of the transmix. For example, when an absolute value of the calculated slope exceeds the absolute value of the threshold, the transmix may be deemed to have started. By using a calculated slope to indicate the start of a transmix, it is possible to better distinguish between normal fluctuations caused by the monitoring instrument and/or changes in the material comprising the initial batch. Once the absolute value of the slope exceeds a predetermined threshold value, the computer may determine that the start of the transmix has occurred. As an example, a threshold value may be selected to be in the range from 0.02 to 0.2 API density units per barrel of material. Using the stored data, the computer may then step backwards through the data to identify when the transmix first arrived at the monitoring instrument. Alternatively, the start of the transmix may be deemed to have occurred by determining where the density vs. volume line (having the calculated slope and intersecting with the data point corresponding to when the calculated slope met or exceeded the threshold slope) intersects with a steady-state density value of the material prior to arrival of the transmix. In this manner, the start of the transmix may be distinguished from fluctuations in the instrument signal that are not due to the transmix.

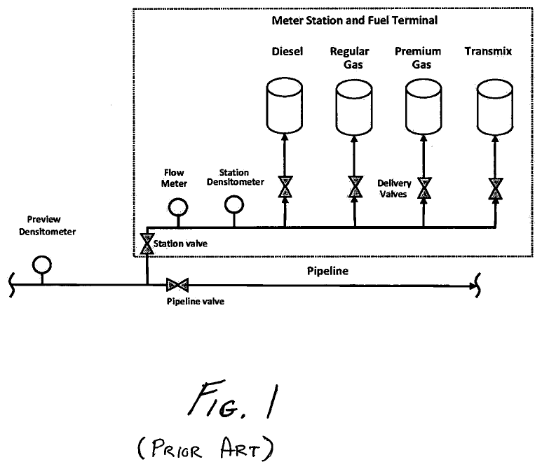

When the monitoring instrument is the preview instrument (See FIG. 1), the computer-calculated start of the transmix indicates the time when the preview instrument detected the start of the transmix. If the preview instrument is located upstream of the fuel terminal delivery valves, operators may be given a warning that the transmix is approaching the fuel terminal so that appropriate action may be taken. It should be noted, however, that this methodology for determining the start of the transmix identifies the start of the transmix after the transmix-start has passed by the preview instrument, and appropriate compensating measures may need to be taken to alter the configuration of the pipeline valves at the proper time.

Allowing the start of the transmix to somewhat pass by the preview instrument before confirming the start of the transmix has occurred allows the system to collect additional data and observe a more significant change in the monitored characteristic prior to confirming the start of the transmix. This added data provides higher accuracy and a higher confidence level regarding the start of a batch change in comparison to prior art methods that identify the batch change based on achieving a density setpoint value.

In order to prevent the computer from falsely indicating the arrival of transmix, the computer may be programmed to expect a batch change after a particular point in time or after a specified volume of material has been moved through the pipeline. The slope calculation algorithm may be turned off, or the results ignored prior to that point in time, or prior to the specified volume being achieved. After reaching the specified point in time or volume, the slope-calculating algorithm may be run periodically and the results may be analyzed to determine when a change from one batch of material to another batch of material is occurring.

In theory, the moment that a change from one batch of material to another occurs could be determined by merely monitoring the volume of material delivered into the pipeline to create the initial batch and then monitoring the volume downstream as the initial batch moves toward the fuel terminal (See FIG. 1). In practice, it may not be possible to rely merely on such volumetric measurements, because (a) the effects of pipeline dynamics (including pipeline pressure and temperature effects), (b) the timing of when batches are added, and (c) mixing that would naturally occur between two dissimilar materials prevents an accurate determination of the start of the transmix. As such, the pipeline operator may need to identify a wide range (temporally and/or volumetrically) during which the transmix is expected to arrive so that calculation of the slope and/or closer monitoring of the slope by the computer may be undertaken prior to arrival of the transmix.

The values of the measured characteristic may be used to predict when an end of the transmix will arrive at the monitoring instrument (Step 3). Using the stored data corresponding to the monitored characteristic, the change in the monitored characteristic over time (or volume) may be quantified and that change may be used to predict when the monitored characteristic is likely to have a value that is equal to or close to the expected value of the subsequent batch of material. Step 3 may be carried out by a computer that is programmed to predict the end of the transmix. Using the stored data gathered from the instrument signal, a computer may calculate the slope of the line that defines the instrument reading vs. volume (or time). The slope may be calculated using a least squares method applied to a number of data points. For example, a least-squares method may be applied to determine the slope of the line corresponding to 30 data points, 500 data points, or some desired number such as a number between 30 and 500. Selecting the most recently stored 200 data points may provide a slope that may be both quickly determined by the computer, representative of the current state of the material in the pipeline, and reduce the effects of short-term variations in the data signal produced by the instrument. The slope value may be updated each time a new data point is stored.

The end of the transmix may be deemed to occur when the slope of the line reaches or crosses a threshold value. Each time the computer recalculates the slope of the line that defines the instrument reading vs. volume (or time), the absolute value of the slope may be compared to the predetermined threshold value, and once the calculated slope reaches or crosses that threshold, the computer may determine that the end of the transmix is approaching or has recently passed the preview instrument. For example, the predetermined threshold value for determining when the end of the transmix is approaching may range from 0.02 to 0.2 API density units per barrel of refined petroleum material pumped through the instrument.

The stored data can often show that the instrument reading asymptotically approaches the actual density and the expected density for the subsequent batch, and for that reason, it may be difficult to definitively identify the point at which the end of the transmix was reached. To more accurately identify an end of the transmix, the computer may use the stored data to calculate a straight-line corresponding to the data provided by the instrument (e.g. density) vs. volume (e.g. via a least-squares fit) and may initially calculate an intercept point at which that line and the expected value for the monitored characteristic (e.g. density) for the subsequent batch intersect. The intercept point indicates the time (or volume) at which transition to the subsequent batch may be essentially complete, and may indicate that the amount of material from a particular batch that may be present in the transmix will not significantly affect the quality of the subsequent batch of material. The intercept point also may be interpreted as indicating when the end of transmix is expected to pass the preview meter. Based on the location of the preview meter and the flow rate of material moving through the pipeline, the computer may determine when the end of transmix will reach the valves that may need to be adjusted in order to send the subsequent batch of material to the desired location.

By determining the end of the transmix in these ways, the invention provides a means for reliably and consistently identifying the end (and start) of transmix. The quantity of data points from an instrument signal that are used, the threshold slopes, and other items may be adjusted to suit the pipeline operating characteristics.

The shape of the data curve representing the transmix passing the monitoring instrument may change from batch to batch based on the operating characteristic of the pipeline, distance the material travels through the pipeline and other factors. In some situations (when compared to others), the data curve may show a steeper transition or a more gradual transition. The intercept point calculated by the invention may fall within or outside the time range of the collected data points for the instrument reading as a function of volume. If the intercept point is within the timeframe of the data set, the end of transmix may have occurred before the instrument reading as a function of volume line was determined. The ability of a method according to the invention to determine the end of transmix (intercept) point that is within (or outside) the data set improves the ability to optimally adjust valves of the pipeline under changing pipeline operating conditions. The instrument reading as a function of volume (or time) line may be optimally determined by many data points so that random error and short-term fluctuations, which are often found in a small portion of such data, do not significantly influence the decisions made.

Importantly, the invention does not require identifying the actual end of transmix before or as it occurs. Of course, the actual end of the transmix may be determined after the transmix end has moved beyond the preview meter, and it may be useful to do so. To determine the actual value of the monitored characteristic, such as density, of the subsequent batch, the computer may continue to perform calculations to identify the line corresponding to the instrument reading as a function of volume (or time) using a similar method as used to predict the end of transmix. Such calculations may continue until the absolute value of the slope becomes near zero, indicating that the instrument reading has reached a steady state. For example, “near zero” may mean that the slope has an absolute value between zero and 0.05, however this example is not intended to limit the invention. This density reading when the slope is at or near zero may be interpreted as the actual density value for the subsequent batch (as compared to the expected density value entered by the human operator before start of the batch delivery). The computer may then re-calculate the intercept point using the actual density of the subsequent batch, and thus provide a more accurate indication of the end of transmix. In doing so, the actual density of the subsequent batch may be calculated using many data points. Determining the actual density may require data from the monitoring instrument to be collected for several minutes after the end of transmix occurs. Calculating the end of transmix using the operator-entered values may provide the operator with an initial indication of the end of transmix while the system may be gathering data to determine the actual density. The end of the transmix may have passed the preview meter before the actual density of the subsequent batch and actual end of transmix is determined, and so the computer may need to account for this delay in determining when to actuate the delivery valves.

Referring to FIG. 2, Steps 5 and 6 identify activities that may be taken in parallel with activities identified in Steps 2 and 3. In Step 5, an algorithm may be executed to determine how much of the transmix is comprised of the initial batch and how much of the transmix is comprised of the subsequent batch at the monitoring instrument. That information, along with the pipeline flowrate may be used to determine the volume occupied by the transmix. It is important to note that the amount of mixing between batches can vary widely based on operating conditions, pipeline length, material type, and other factors. Therefore, this methodology can provide an estimate of the transmix volume. Although an estimate, such an estimate may be useful for predicting when the transmix will end. Once the transmix volume is calculated, by knowing when the transmix started (See Step 2) and the volumetric flow rate of material through the pipeline, the time at which the end of the transmix will occur can be predicted. In Step 6, the end of the transmix may be predicted. The prediction regarding when the transmix will end may be used to better identify when the pipeline system may need to be modified, thereby assisting the operator or an automated system with changing the configuration of the pipeline system.

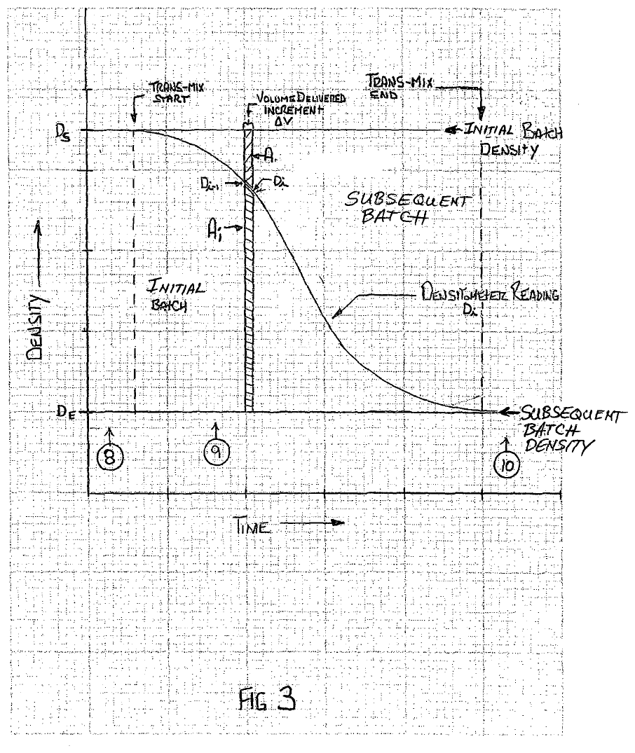

FIG. 3 shows an idealized change in observed density when transitioning between batches that differ in density. As noted above, composition of the transmix at a particular time may be estimated based on the density reading for that time. The density reading, along with the date, time, and incremental volume may be stored in a storage device that may be in communication with the computer. The incremental volume may be determined by monitoring the delivery station flowmeter. For example, the density reading, date, and time may be logged as data each time the volume delivered increases by one barrel of material.

The volume increment may be the flow increment observed on the station flowmeter between data logging each density value. Upon receiving a new density value, the computer may calculate the respective proportions of Ai and As using the assumed density values for the initial material and subsequent material. “Ai” is defined as the area under the curve for an incremental flow volume and is related to the initial batch. “As” is the area above the curve and is related to the subsequent batch. The widths of the Ai and As areas may represent a volume increment or may represent a time increment. By repeating this process for many incremental volumes, many individual Ai and As values may be obtained. The relative areas for Ai (initial batch of material) and As (subsequent batch of material) may be used to calculate the relative fraction of each batch in the transmix. The total transmix volume may be the volume between the start of transmix and the end of transmix. The overall composition of the transmix may be expressed as the ratio of the initial batch and subsequent batch areas. Ai and As may calculated based on an average of the density reading at the beginning and end of each interval. The Ai and As areas for each interval from the start of transmix to the end of transmix may be calculated and stored. In addition, the sum of the individual Ai areas and As areas may be calculated.

The shape of the transmix density curve may be determined as the transmix flows past the monitoring instrument (in this example, the densitometer). Although the end of the transmix may be predicted, the actual end of the transmix may be not determined until after the transmix has passed by the monitoring instrument. The Ai and As area data may be calculated, totalized, and stored until the end of transmix is determined (e.g. via the methodology described above). The calculation of Ai and As require a value for the subsequent batch density. That being the case, the values of Ai and As may be initially calculated using the expected value for the subsequent batch density (De). De may be a value that may be entered by the pipeline operator based on batch material data or past experience. Once the transmix zone passes the densitometer, the densitometer can provide an actual value for the subsequent batch density. If the actual density of the subsequent batch is different from the operator-entered value, the entire series of Ai and As areas may be recalculated based on the actual density value in order to increase accuracy.

In response to detecting a batch change, a change to the pipeline configuration may occur, for example, by actuating delivery valves so that delivered material is diverted from one storage tank to another at the proper time. Such a change to the pipeline system may occur prior to, during or after the transmix passes the valve to be actuated. Item 8 on FIG. 3 identifies a time prior to the transmix. This time may be selected for changing valve positions when the initial batch cannot tolerate the presence of any material from the subsequent batch, such as a transition from a diesel to gasoline. Item 9 on FIG. 3 identifies a time during the transmix. This time may be selected for changing valve positions when a transition between similar materials will occur, such as a transition between premium and regular gasoline. Item 10 on FIG. 3 identifies a time after the end of the transmix. This time may be selected for changing valve positions when the subsequent batch cannot tolerate the presence of the initial batch.

To predict when to change the valve, the algorithm may calculate the volume of material in the pipeline that should pass by the valve before the valve is actuated in order to change storage tanks. Since the flow rate is known, such a calculation may be expressed as a time for effecting the valve change. For valve changes that occur during the passage of the transmix, the algorithm may calculate the quantity of cross mixing for the batches. In this way, the pipeline operator can make better decisions for future similar transitions.

A system without automation relies on the human operator to make an educated guess regarding when the transmix arrives at the station delivery valves. Such an operator may anticipate the volume (or time) at which he/she will take action to actuate the valves. To do this, the operator may observe changes in the preview meter reading. Once the operator believes the transmix has passed the preview meter, the operator may set or note a volume (or time) countdown to the station based on the volume (or flowrate) of the pipeline between the preview meter and the valve.

The pipeline operator may make an educated guess and add or subtract volume (or time) from the expected batch change point to achieve desired material purity. For example, for a transition from premium gasoline (initial batch material) to regular gasoline (subsequent batch material), the operator may actuate the valve prior to arrival of the transmix in order to change from delivering to the premium storage tank to the regular storage tank before the premium to regular transmix reaches the delivery valves. In this way, the operator can assure that the storage tank for premium gasoline will not contain any regular gasoline, and thereby maintain the purity of the premium gasoline in the storage tank. However, an overly conservative early change of the valve will send more premium gasoline to the storage tank for regular gasoline, and thereby result in a loss of value (downgrade of higher value premium gasoline to regular gasoline).

Once the start and end of the transmix is determined at the preview meter, the computer calculates when the start and end of the transmix will reach the delivery valve based on the volume of the pipeline in the section of pipeline between the preview meter and the valve station. By using an embodiment of the invention, the operator may be provided with improved information on the batch arrival time and thus allow the operator to initiate the batch change activities, such as activating one or more of the delivery valves, at a time that may be close to ideal. For highly automated systems, the invention can be used to automatically actuate the valve and perform the necessary batch change activities (where the operator would merely monitor the batch change activities, and not actually perform them). Automating the batch change activities may require corresponding automation of delivery station valves and other equipment.

Providing the operator with a clearer start and end of transmix reduces guesswork in deciding when to change a configuration of a pipeline system. It also may maintain or improve product quality, while also reducing the loss in value that may arise due to downgrading of material and may reduce transmix volumes. Providing the operator with the transmix composition as it passes the delivery valves may allow the operator to make a change to the pipeline configuration while also being confident that the mixing between batches will be within required limits, and thus maintain the quality of adjacent batches.

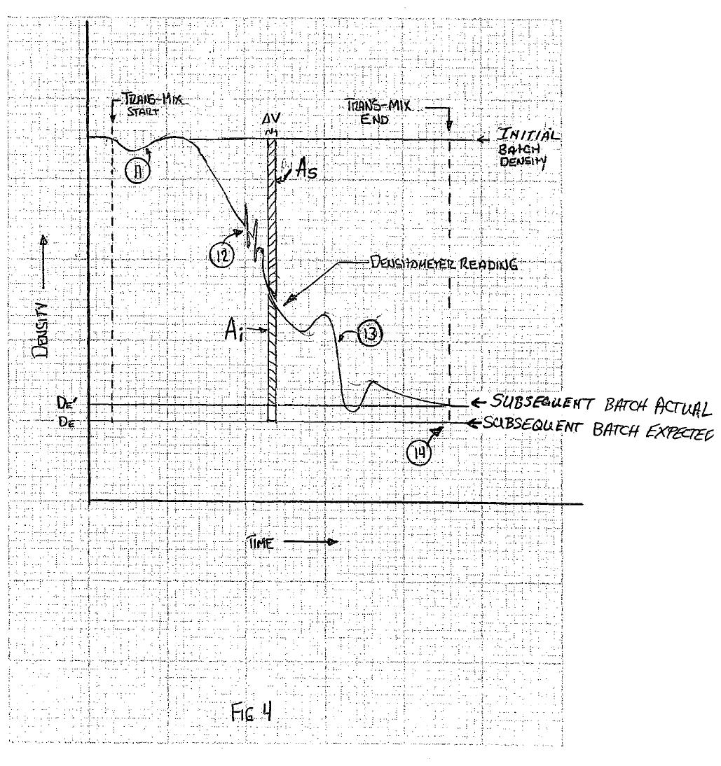

In contrast to FIG. 3, FIG. 4 shows a more realistic change in density when transitioning between batches that differ in density. The change in density depicted in FIG. 4 is not as steady as that shown in FIG. 3. The start of a batch change (see Item 11) may show initial fluctuations in the material characteristic being monitored (e.g. density) prior to a more significant composition change. The material characteristic may be monitored frequently. To prevent a premature determination regarding the arrival of the transmix, a computer may be used to complete a least squares calculation to determine the slope of the density vs. time line using, for example, 200 or more data points with each point at an incremental volume (e.g. barrel) of flow. Once the calculated slope exceeds a predetermined threshold, the computer may determine that the start of the transmix has occurred. Item 12 identifies instrument signal noise and short-term variability of the density meter signal. To minimize the effects of such noise, the invention may use input signal damping built into the control system hardware or software, or may use averaging of some number of most recent density data points to effectively dampen short-term variations in the instrument signal. Item 13 identifies variability in the characteristic being monitored by the monitoring instrument that could cause an erroneous determination that the transition is complete because there is a steep drop in density that appears headed toward the expected subsequent-batch density. The computer may collect and analyze data beyond the anticipated end of batch transition to reduce the chance that it will respond to a short-term fluctuation by prematurely concluding that the transmix has ended. Item 14 indicates a situation in which the operator-entered expected subsequent batch density is different from the actual density.

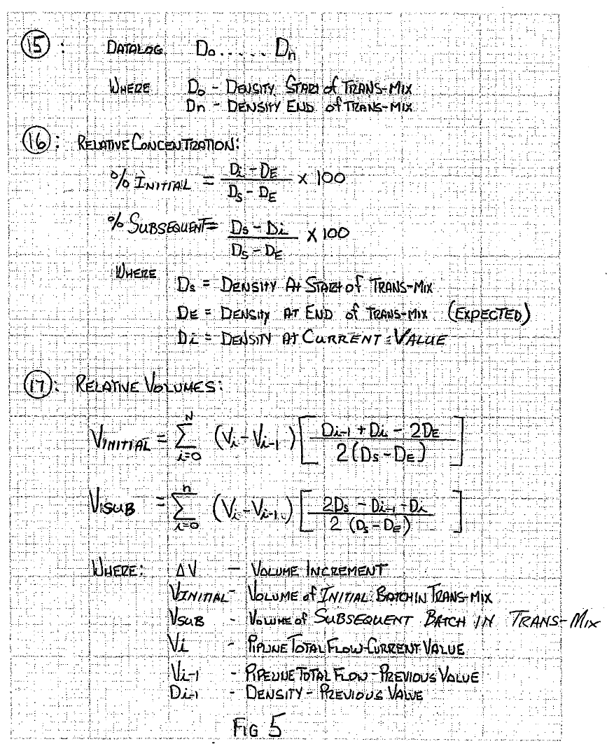

FIG. 5 shows aspects of the algorithm executed by the computer that may be employed for the invention. Item 15 represents the continuous rolling data logging of the monitored characteristic (e.g. density). The characteristic value may be logged each time a predetermined amount of material flows past a monitoring instrument. That predetermined amount may range, for example, from 1 to 20 barrels. The duration of data storage may be, for example, a minimum of one hour. Logging of data should allow for the collection and storage of data from prior to the beginning of the transmix because the start of the transmix may not be immediately identified, and indeed will likely be identified after the transmix begins. Once the start of the transmix has been recognized, the computer may then calculate the start point after it has been decided that a transition from one batch to another is occurring.

With the predictions from Step 3 and/or Step 6 in hand, in Step 4, one or more valves associated with the pipeline may be actuated at one of the predicted times, or at a time that is between those predicted times. Such valves may be actuated manually or via an electro/mechanical actuator in order to switch the destination of material delivered by the pipeline for example, from one storage tank to another storage tank.

Step 7 indicates that the computer may be used to carry out recalculations of the calculations previously carried out in order to provide predictions. Prior to Step 7, predictions are sought and then used to determine when to actuate one or more valves. As the transition from one batch to another proceeds, the end of the transmix may be predicted based on the operator-entered anticipated instrument reading for the subsequent batch and the setting for the threshold slope. Since the actual density reading of the subsequent batch may vary and can be confirmed only after the subsequent batch is well past the preview meter, after the transition from one batch to another is complete, the actual value for the monitored characteristic of the subsequent batch may be used to predict the behavior of future batch changes. The transmix destination and composition data may be stored to allow future assessment in order to improve future operation.

After the density reading for the subsequent batch reaches steady state, the computer may recalculate and adjust the transmix composition to be consistent with the actual recorded data. The computer may calculate the fraction of the initial batch and the subsequent batch that makes up the transmix at the preview and station densitometers. A monitor may provide the operator with an indication of the transmix composition. Such a display of the transmix composition may become active when the material flowing through the pipeline at the preview meter changes.

In systems that do not employ embodiments of the invention, the pipeline operator or pipeline automation uses the monitored characteristic as a basis for batch changes, but does not have a means of correlating the instrument readings to the transmix composition corresponding to the batch change. It will now be appreciated that the invention seeks to provide the pipeline operator (or automated system) with added information with which to make adjustments to the pipeline configuration that are appropriate and possibly ideal. The invention seeks to provide a means for determining when to modify a pipeline system that is based on measurements of the composition of the material flowing through the pipeline system.

Once the start of the transmix is identified, the computer may calculate a relative ratio of the current and subsequent batches in the transmix using equations in item 16. The relative ratios may be displayed on the operator's display and may be updated at each calculation interval. The computer may calculate the relative volumes for each interval and the sum for the total volumes in the transmix.

Once the start of the transmix is determined, the measured characteristic data from that point going forward to the end of the transmix may be used to start populating a transmix data table. Measured characteristic data may be logged with each volume increment (e.g. one barrel of flow as measured by the station flowmeter). For each volume increment, the relative percent of each material in the transmix and volume may be determined and recorded.

The equations described in Item 16 may be used to calculate the percent composition of the current and subsequent batches in the transmix. The material of the percent composition and incremental volume may be used to determine volume of the current and subsequent batch in each incremental volume. In addition, the cumulative total volume of current and subsequent batch contained in the transmix may be calculated with each volume increment. To complete the desired calculations, the density value for the subsequent batch may be required, and so the subsequent batch density value may be estimated since the subsequent-batch density may not be known until after the transmix passes. By providing an estimate of the subsequent batch density, the calculations may proceed and the results displayed during the transition. After the actual subsequent batch density is determined, the previous calculated data obtained using the estimated density may be replaced with data calculated using the actual density for the subsequent batch.

The calculation methodology for the cumulative volume of current and subsequent batch material in the transmix is described in Item 17. The start of the transmix may be used as the summation start point where i=0. The end of transmix may be used to determine the endpoint of the summation (the n value). The product of n and the increment volume may determine the total transmix volume. This may also be determined by taking the station flowmeter totalized volume value at the end of the transmix and subtracting the totalized flow at the start of the transmix. The end of the transition may be represented by data values obtained when the volume increment equals n. Once the end of the transition is determined, the actual value of the subsequent batch density (DE′) may be determined from the data provided by the instrument reading at n+1. If the actual value is different from the expected subsequent batch density (DE), the entire transition zone series may be recalculated based on the actual density value.

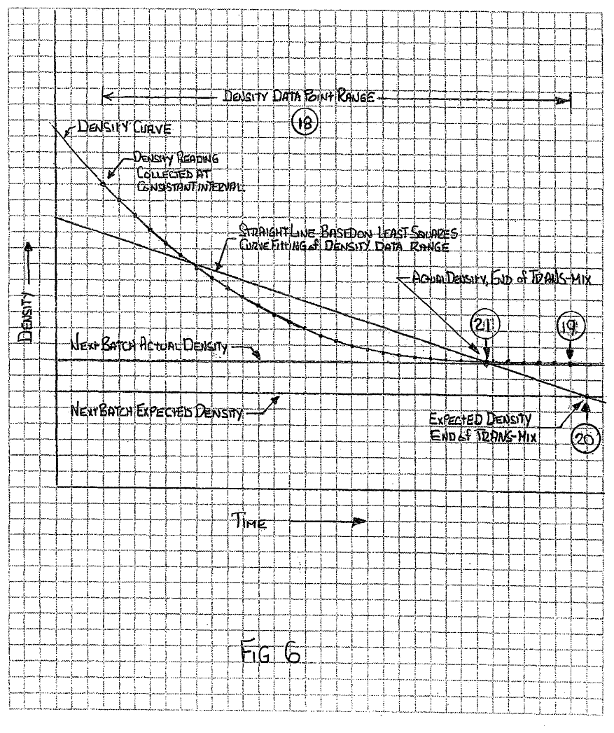

FIG. 6 shows a portion of an example density vs. time curve at the end of the transmix. The system may collect density data for a delivered volume to provide a range over which there is density data (see Item 18). The data set may consist of a desired number of data points, for example 200 data points. If data storage is limited, with each new data point collected, the oldest data point in the set may be eliminated. With each new data point, the computer may calculate the slope of the line using a least squares curve fitting method. This may continue until the expected end of the transmix is reached. At this point, the data set and calculated line may be retained. Item 20 identifies the point at which the computer may identify that the end of the transmix is approaching or may have recently occurred. Since the computer uses many data points to calculate the slope, the end of transmix may pass the preview meter before the end of transmix is identified by the computer. The computer may initially calculate the intercept between the retained line and expected subsequent batch density at Item 20.

After the transmix has passed by the preview meter, the computer may continue to calculate the slope until the slope becomes near zero or may have an absolute value that is nearly zero (e.g. between 0.01 and 0.05). The density reading when the slope is zero (or near zero) represents the actual subsequent batch density. To increase the accuracy, the computer may then re-calculate the end of the transmix point using the actual subsequent batch density. This is shown as Item 21. The use of many data points in calculating the slope improves the reliability and consistency of identifying the end of the transmix. Collecting readings from a preview meter allows the pipeline control system and/or a human operator time to react prior to the transmix reaching the delivery valves.

After a batch change occurs, the computer may calculate, display, and data log for future reference the amount of cross mixing between adjacent batches and the impact on batch composition. For example, the computer may determine that due to the transmix and timing of the batch change, the subsequent batch contains X barrels of the initial batch material, and that X constitutes Y percent of the total volume of the batch. The cross mixing may be expressed as the volume portion of the transmix that is not the desired batch material.

The change of pipeline configuration may be accomplished by the actions of an operator to actuate delivery valves or by the actions of an automated system. In the situation where an automated system is used, the operator may merely observe the data as provided by the monitoring instrument and as calculated by the computer, assess impact of the batch change timing in terms of acceptable cross mixing, and consider if the basis for the batch change was appropriate, overly conservative, or may risk affecting material quality. In some circumstances, the operator may complete a batch change before the start of the transmix or after the end of the transmix. The computer may be used to determine the actual cross mixing between batch materials and in some cases may include data corresponding to volumes outside the transmix. By observing a quantified value for the cross mixing, the operator may learn how to more efficiently make future batch changes.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A method of operating a pipeline conveying two dissimilar materials, comprising:
(a) gather data corresponding to a measured characteristic for material flowing in a pipeline that has valves for directing the material to desired locations;
(b) identify a first line that is representative of a first subset of the gathered data;
(c) determine a slope of the first line;
(d) determine whether an absolute value of the slope of the first line is less than, equals, or exceeds a first threshold value;
(e) if the absolute value of the slope of the first line is determined to be less than the first threshold value, then return to step “a”;
(f) if the absolute value of the slope of the first line equals or exceeds the first threshold value, then:
(i) send a message indicating that transmix has been detected;
(ii) continue gathering data corresponding to the measured characteristic;
(iii) identify a second line that is representative of a second subset of the gathered data, the second subset including data gathered in step “(f)(ii)”;
(iv) determine a slope of the second line;
(v) determine whether an absolute value of the slope of the second line is less than, equals, or exceeds a second threshold value;
(vi) if the absolute value of the slope of the second line exceeds the second threshold value, then return to step “ii”;
(vii) if the absolute value of the slope of the second line equals or is less than the second threshold value, then send a message that the transmix has ended;
(viii) in response to the message that the transmix has ended, modify a position of at least one of the valves to direct the material to a desired location via the pipeline.

2. The method of claim 1, wherein step “a” is carried out by a monitoring instrument mounted on and/or in the pipeline.

3. The method of claim 2, wherein the monitoring instrument is mounted upstream of the at least one valve.

4. The method of claim 2, wherein the monitoring instrument is a densitometer.

5. The method of claim 2, wherein the monitoring instrument is an optical interface detector.

6. The method of claim 5, wherein the optical interface detector monitors absorption, fluorescence, refractive index, color, haze or turbidity.

7. The method of claim 1, wherein identifying the first line, the second line, the first slope, and the second slope is carried out by one or more computers executing instructions of a software program.

8. The method of claim 1, wherein step “d” is carried out by one or more computers executing instructions of a software program.

9. The method of claim 1, wherein steps “i” through “vi” of step “f” are carried out by one or more computers executing instructions of a software program.

10. The method of claim 1, wherein step “viii” of step “f” is carried out so that the position is modified before the transmix arrives at the valve.

11. The method of claim 1, wherein step “viii” of step “f” is carried out so that the position is modified after the transmix has passed the valve.

12. The method of claim 1, wherein step “viii” of step “f” is carried out so that the position is modified after the transmix arrives at the valve, but before the transmix has passed the valve.

13. The method of claim 1, further comprising determining a volume occupied by the transmix.

14. The method of claim 13, further comprising determining that the transmix has passed when a volume measured by a flow meter residing downstream of a location where step “a” is carried out exceeds the determined volume of the transmix.

15. A system for operating a pipeline conveying two dissimilar materials, comprising:
(a) a monitoring instrument for gathering data corresponding to a characteristic for material flowing in a pipeline that has valves for directing the material to desired locations;
(b) one or more computers programmed to:
(i) identify a first line that is representative of a first subset of the gathered data;
(ii) determine a slope of the first line;
(iii) determine whether an absolute value of the slope of the first line is less than, equals, or exceeds a first threshold value;
(iv) if the absolute value of the slope of the first line is determined to be less than the first threshold value, then return to step “a”;
(v) if the absolute value of the slope of the first line equals or exceeds the first threshold value, then:
(A) send a message indicating that transmix has been detected;
(B) continue gathering data corresponding to the measured characteristic;
(C) identify a second line that is representative of a second subset of the gathered data, the second subset including data gathered in step “B”;
(D) determine a slope of the second line;
(E) determine whether an absolute value of the slope of the second line is less than, equals, or exceeds a second threshold value;
(F) if the absolute value of the slope of the second line exceeds the second threshold value, then return to step “B”;
(G) if the absolute value of the slope of the second line equals or is less than the second threshold value, then send a message that the transmix has ended.

16. The system of claim 15, wherein the monitoring instrument is mounted on and/or in the pipeline.

17. The system of claim 16, wherein the monitoring instrument is mounted upstream of the at least one valve.

18. The system of claim 16, wherein the monitoring instrument is a densitometer.

19. The system of claim 16, wherein the monitoring instrument is an optical interface detector.

20. The system of claim 19, wherein the optical interface detector monitors absorption, fluorescence, refractive index, color, haze or turbidity.

21. The system of claim 25, wherein the computer is further programmed to modify a position of at least one of the valves to direct the material to a desired location via the pipeline in response to the message that the transmix has ended.

22. The system of claim 21, wherein the position of the valve is modified so that the position is modified before the transmix arrives at the valve.

23. The system of claim 21, wherein the position of the valve is modified so that the position is modified after the transmix has passed the valve.

24. The system of claim 21, wherein the position of the valve is modified so that the position is modified after the transmix arrives at the valve, but before the transmix has passed the valve.

25. The system of claim 15, wherein the computer is further programmed to determine a volume occupied by the transmix.

26. The system of claim 25, wherein the computer is further programmed to determine that the transmix has passed when a volume measured by a flow meter residing downstream of the monitoring instrument exceeds the determined volume of the transmix.
